(19) United States
(12) Patent Application Publication
(10) Pub. No.: US 2014/0310104 A1
(43) Pub. Date: Oct. 16, 2014

(54) ADVERTISEMENT DELIVERY METHOD

(71) Applicant: Vivalect AB, GÖTEBORG (SE)

(72) Inventors: Philip Lundin, Goteborg (SE); Hani Glaidos, Uppsala (SE)

(21) Appl. No.: 14/359,654

(22) PCT Filed: Nov. 23, 2012
(86) PCT No.: PCT/SE2012/051296

§ 371 Date: May 21, 2014

(30) Foreign Application Priority Data
Nov. 24, 2011 (EP) 11190502.2

(51) Int. Cl. G06Q 30/02

(52) U.S. Cl. CPC G06Q 30/0267
USPC 705/14.64

(57) ABSTRACT

It is provided a method for distributing a multimedia message to a user having an electronic communication device comprising a packet based communication application stored thereon, the method comprising initiating a communication between the user and a recipient using the packet based communication application, determining the availability of a multimedia message stored locally on a the electronic communication device, providing the locally stored multimedia message to the user, connecting the user to the recipient for allowing a communication between the user and the recipient when the multimedia message has been provided to the user, requesting an updated multimedia message based on a profile of the user, and storing the updated multimedia message locally on the electronic communication device.

### FIELD OF THE INVENTION

The present invention relates to communication systems. More particularly, the present invention relates to advertisements in communication systems.

### TECHNICAL BACKGROUND

In telephone communication systems, it is known to play a message to a caller instead of the traditional connection tone when a phone call is being connected. Such a message may for example be a hold message or music.

The message may also contain commercial information such as a commercial jingle promoting the operator used when making the call. Some adaptations have been made to implement a similar technique in relation to VOIP communication.

US2009046704 discloses a corresponding method for targeted advertising, which is carried out by maintaining respective profiles of a group of individuals who are affiliated with an organization, providing the individuals with access to a packet telephony service (e.g. VOIP, sometimes denoted as “soft phones”), and receiving a request from an individual in the group to establish a telephonic connection with a recipient over a packet network using the packet telephony service. In response to the request, the method is further carried out by transmitting over the packet network to the individual a notification (e.g. a commercial jingle) provided by the organization and targeted according to a respective profile of the individual, and completing the telephonic connection.

Even though US2009046704 discloses a promising approach for including a notification, e.g. a commercial jingle, with a VOIP based phone call, US2009046704 fails to disclose means for optimizing the actual integration and distribution of the notification to individual making the call.

Accordingly, it would be desirable to provide improvements specifically in relation to the selection of which notification to play for a specific individual as well as minimizing any possible waiting periods for the individual making the call.

### SUMMARY OF THE INVENTION

In view of the above-mentioned desired properties of advertising in a communication system, and the above-mentioned and other drawbacks of the prior art, it is an object of the present invention to provide an improved system for providing commercial information to a caller.

According to a first aspect of the present invention, it is therefore provided a method for distributing a multimedia message to a user having an electronic communication device comprising a packet based communication application stored thereon, the method comprising initiating a communication between the user and a recipient using the packet based communication application, determining the availability of a multimedia message stored locally on the electronic communication device, providing the locally stored multimedia message to the user, connecting the user to the recipient for allowing a communication between the user and the recipient when the multimedia message has been provided to the user, requesting an updated multimedia message based on a profile of the user, and storing the updated multimedia message locally on the electronic communication device.

The present invention is based on the realization that optimization of the user experience partially may be provided by specifically selecting when in the operational process the electronic device receives an updated multimedia message to be subsequently provided to the user of the electronic communication device. That is, the inventors have realized that provision of the multimedia message from a local storage at the electronic communication device minimizes any waiting period that for example may appear in case of the multimedia message being streamed from a remote server. That is, temporary problems with low streaming bandwidth will according to the invention have no effect on the provision of the multimedia message to the user. Instead, an updated version of the multimedia message is downloaded and stored locally at the electronic communication device prior to being provided to the user. Furthermore, it may be possible to download an updated version of the multimedia message when no communication is present, or even more preferably when the electronic communication device has limited network connectivity.

In the context of the present invention, it should be noted that the term application may indicate for example a computer based application such as an “App” of a handheld device such as a mobile phone or tablet, or relate to computer software running on a laptop or stationary computer.

Also, within the context of the present invention the multimedia message may be an audio message and/or a video message. The audio message may be distributed through the same component of the electronic communication device as through which the communication between the user and the recipient is provided (e.g. a speaker of the electronic communication device). The video message may be provided using a display comprised with the electronic communication device, for example within a graphical user interface (GUI) of the electronic communication device.

The user should in the present context be understood as the party originating a request for communication. The receiver should in the present context be understood as the intended recipient of the communication. The receiver may be any entity such as a land-line telephone subscriber, a mobile telephone subscriber or any equivalent entity.

A method according to the present invention may advantageously be incorporated in a system where free or discounted telephone services are offered in exchange for listening to commercial messages.

According to a preferred embodiment of the invention, the method further comprises providing information relating to at least one information parameters of the profile of the user and information relating to the provided multimedia message to a management server.

In one embodiment of the invention, parameters of the profile of the user may advantageously comprise information selected from the group comprising caller interests, hobbies, line of work, family status, geographical area, age and gender.

In one embodiment of the invention, at least one information parameters of the profile is requested from an online community possibly identifying the user. Also, the profile of the user may be updated depending on the profile of the recipient. That is, if the user and the recipient have indicated some sort of connection (e.g. Facebook friends, connected through Linkedin, MSN, etc.) it may be possible to “share” some profile features between the recipient and the user. Accordingly, related multimedia messages may be provided to both the user and the recipient (i.e. when the recipient in turn is initiating a call, in such a case being the user), thus possibly initiating common interest in a campaign relating to the provided multimedia message.

In an alternative embodiment the electronic communication device further comprising an advertising delivery plug-in stored thereon, and the method further comprises intercepting the initiation of communication between the user and the recipient, wherein the advertising delivery plug-in performs determining the availability of and provision of the multimedia message and the request and storage of the updated multimedia message.

Preferably, the advertising delivery plug-in further comprises requesting at least one information parameters of the profile from the packet based communication application.

In a preferred embodiment a plurality of multimedia messages are stored locally on the electronic communication device, and one of the plurality of multimedia messages is selected to be provided to the user based on a plurality of predetermined criteria, the predetermined criteria selected from a group comprising priority of a specific multimedia message and the number of times a specific multimedia message has been provided to the user. Accordingly, matching of multimedia messages provided to the user may be achieved, e.g. based on pre-set criteria relating to an advertising campaign comprising a plurality of multimedia messages.

According to another aspect, there is provided a computer program for causing a control unit to apply the method as discussed above. This aspect provides similar advantages as discussed above. The computer readable medium may be one of a removable nonvolatile random access memory, a hard disk drive, a floppy disk, a CD-ROM, a DVD-ROM, a USB memory, an SD memory card, or a similar computer readable medium known in the art.

According to a further aspect of the present invention, it is provided an electronic communication device, comprising a control unit configured to execute a packet based communication application on the control unit, initiate a communication between the user and a recipient using the packet based communication application, determine the availability of a multimedia message stored locally on a the electronic communication device, provide the locally stored multimedia message to the user, connect the user to the recipient for allowing a communication between the user and the recipient when the multimedia message has been provided to the user, request an updated multimedia message based on a profile of the user, and store the updated multimedia message locally on the electronic communication device.

Effects and features of this aspect of the present invention are largely analogous to those described above in connection with the previously disclosed aspect of the invention. The electronic communication device may for example be one of a mobile phone, tablet, laptop or stationary computer. Similar future devices may be possible and within the scope of the invention.

According to a still further aspect of the present invention, it is provided a server for managing delivery of a multimedia message to a user of an electronic communication device comprising a packet based communication application stored thereon, wherein the management server is configured to receive information relating to at least one information parameters of the profile of the user, receive information relating to a multimedia message provided to the user of the electronic device, match an updated multimedia message to the profile of the user, and provide the updated multimedia message for the user. Also this aspect provides similar effects and features to those described above in connection with the previously disclosed aspect of the invention.

The management server may be configured to connect to an online community possibly identifying the user, request at least one information parameters relating to the profile of the user, and update the profile of the user based on the requested information parameter. Accordingly, information parameters may be extracted from the online community and included in the profile of the user.

Furthermore, the management server may be configured to provide a user interface (UI) for operating the management server, receive, by means of the UI, information relating to an advertisement campaign comprising at least one multimedia message, provide, through the UI, information relating to at least one parameter of the profile of the user, and provide, through the UI, information relating to the multimedia message provided to the user of the electronic device. Using such a configuration, a back-end may be provided for managing e.g. advertising campaign comprising a plurality of multimedia messages.

Additionally, the management server may be configured to perform statistical analysis based on information relating to at least one information parameters of the profile of the user and information relating to a multimedia message provided to the user of the electronic device, and provide, through the UI, campaign data based on the statistical analysis. Accordingly, the management server may be an integral part of a Content Management System (CMS) for handling administrative and business elements in relation to the present invention.

Other objectives, features, and advantages of the present invention will appear from the following detailed disclosure, from the attached dependent claims as well as from the drawings.

### BRIEF DESCRIPTION OF THE DRAWINGS

These and other aspects of the present invention will now be described in more detail with reference to the appended drawings showing a currently preferred embodiment of the invention, wherein:

FIG. 1 exemplifies a communication system according to an embodiment of the invention, and

FIG. 2 schematically illustrates a flowchart for providing a multimedia message according to an embodiment of the invention.

### DETAILED DESCRIPTION OF PREFERRED EMBODIMENTS OF THE INVENTION

In the present detailed description, various embodiments of a method for providing a message in a communication system according to the present invention are mainly discussed with reference to a system for telephone communication. It should be noted that this by no means limits the scope of the present invention which is equally applicable to other forms of communication systems.

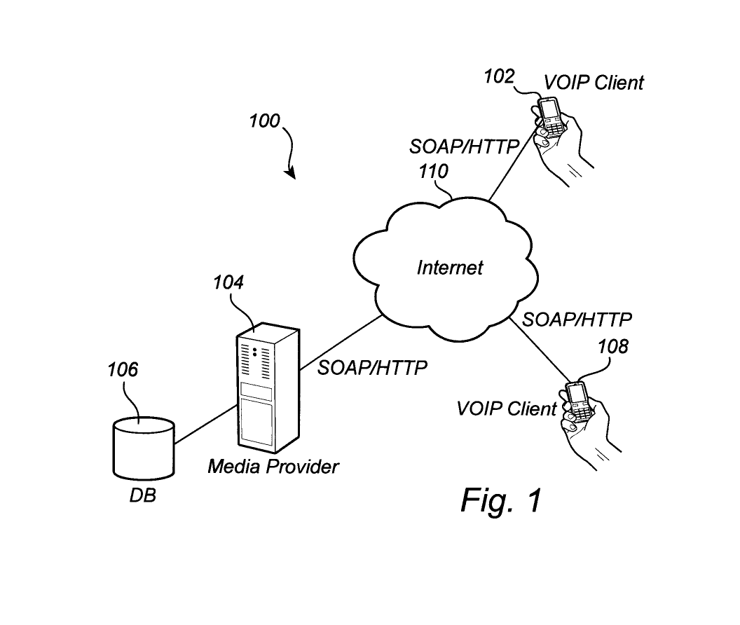

FIG. 1 schematically illustrates a communication system 100 according to an embodiment of the present invention. The communication system 100 supports delivery of media content in the form of a multimedia message (e.g. audio and/or video) to an arbitrary initiating VOIP client (Voice over IP), i.e. a calling part 102. In the exemplified embodiment the communication application Skype™ is used for exemplify some of the functionality of the present invention. As understood by the skilled person, an arbitrary SIP-client or any other similar e.g. packet based communication applications could be used within the context of the present invention, including for example MSN, HamSphere, Ooma, RingCentral and Radvision.

The communication system 100 further comprises a Media Provider Service 104 and a thereto connected database 106. Communication between the calling part 102, the Media Provider Service 104, and a receiving part 108 of the communication system 100 is performed over a network such as the Internet 110.

The Media Provider 104 is the backend of the system and may for example be implemented as a Windows Communication Foundation (WCF) service. The main purpose of the Media Provider 104 is to analyze the criteria parameters and deliver content to a consumer based upon the given parameters e.g. gender, age, etc. When the consumer uses the Skype Application, criteria parameters from the users Skype profile (user profile) are sent to the Media Provider 104. The Media Provider 104 matches the parameters against active advertisement campaigns and delivers media content (multimedia messages) relevant to the consumer (e.g. the caller/user).

The media is delivered to the consumer when the consumer makes an outgoing call using Skype. When the content is delivered, the call is routed to the receiving part 108. The Media Provider 104 stores information about which content is delivered and how many times the content has been played for a specific user. This data is used for decision making (which content to deliver). This data could also be used for exposure analysis and statistics to provide feedback to advertisers, for example through a user interface (UI) provided at the Media Provider 104 for administering the advertisement campaign. In a possible scenario, a Content Management System (CMS) e.g. SharePoint, could be used to provide the content to the Media Provider 104. A custom advertisement market application could also be used to provide a marketplace and to configure advertisement campaigns.

In the illustrated embodiment of the invention, a plug-in facilitates the communication between the Media Provider 104 and the Skype client (i.e. the calling part 102). The plug-in may for example be based upon Microsoft's .NET Framework 4.0 and uses the public available Skype4COM API which is a COM-wrapper for the public Skype API. In a possible embodiment the plug-in could be an integral part of the Skype Application.

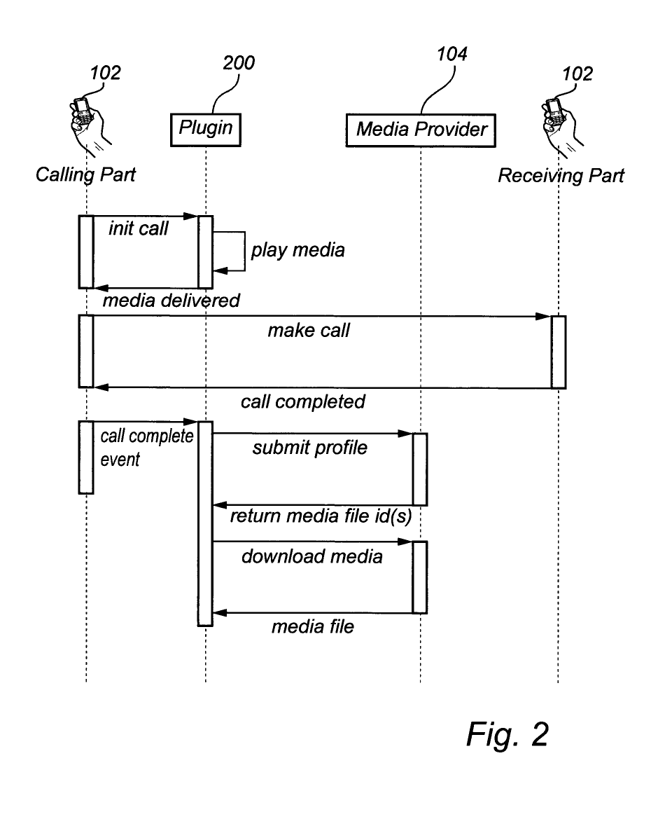

During operation of the communication system 100, with reference also to FIG. 2, the calling part 102 initiates a call to the receiving part 108. The call is intercepted by the plug-in 200. Note that the call is intercepted before the call is actually made such as for example based on an interception on application level events. The plug-in 200 checks the local media repository of the electronic communication device of the calling part 102 for at least one multimedia message to play to the user of the calling part 102. The plug-in 200 then plays the media file.

When the multimedia message has been delivered (file has been played and reached end of file) an event is triggered by the plug-in 200 that changes the state and enables the call to be made. Subsequently, the call is made to the receiving part 108. When the call is completed (calling or receiving part ends the call), the plug-in 200 sends the users profile data to the Media Provider 104. The Media Provider 104 then analyzes the profile data and returns a number of unique id's (representing media files matching the user's profile). Following the analysis, the plug-in downloads an updated multimedia message which possibly replaces the contents of the local repository.

At the electronic communication device of the calling part 102, it is possible to log when a specific multimedia message was played. The logging of media content delivery may be used as a parameter in a decision making, relating to a match making method for selecting which specific multimedia message to provide to the calling part 102. Additionally, history logging includes exposure analysis and may be provided as a feedback to advertisers.

The match making method is used for delivering multimedia messages that are relevant to the user (calling part 102) possibly based primarily on the profile of the user. In an embodiment, an advertisement campaign may have properties including for example validity period (Valid From (date)-Valid To (date)), selection criteria and priority. The selection criteria define a set of variables that is used to target a specific group of users/customers e.g. gender and age-span. The selection criteria may be defined dynamically and may contain a variable number of user defined properties. Defining custom criteria may possibly be done when setting up a campaign.

As discussed above, it is possible store history information relating to for example when a multimedia message was delivered (stored locally) to a user (date and time), when the multimedia message file is played/provided to the user (date and time) and how many times a specific multimedia message is played for a specific user. The priority is a concept introduced to support marketing and sales of advertisements, a more expensive advertisement has precedence over low-cost campaigns and guarantees more customer exposure.

The outcome of the history and the priority described above is a weighted value defined as the product of Count*Priority in the table below (Table 1). Count is the number of times the media file has been played and Priority is the start priority for the given advertisement campaign. The start priority and interval (10, 12, and 14) are arbitrary values.

TABLE 1

| Advertisement campaign | Count | Priority | Weight |
|---|---|---|---|
| 1 | 8 | 10 | 80 |
| 2 | 6 | 12 | 72 |
| 3 | 6 | 14 | 84 |

In the example given in Table 1, the Advertisement campaign number 2 has the lowest weight. The next time the Media Provider 104 delivers media, a multimedia message relating to the Advertisement campaign number 2 will be played (based on the lowest weight).

TABLE 2

| Advertisement campaign | Count | Priority | Weight |
|---|---|---|---|
| 1 | 8 | 10 | 80 |
| 2 | 7 | 12 | 84 |
| 3 | 6 | 14 | 84 |

With reference to Table 2, when the Advertisement campaign has been played the Count is incremented, rendering a new value for the weight parameter. Now Advertisement campaign number 1 has the lowest weight and a multimedia message relating to the will be played next.

Accordingly, by means of the match making method improvements in which multimedia message that in fact is delivered to the user is achieved. Additionally, parallel running advertisement campaigns may be handled in an improver manner.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The invention has mainly been described above with reference to a few embodiments. However, as is readily appreciated by a person skilled in the art, other embodiments than the ones disclosed above are equally possible within the scope of the invention, as defined by the appended patent claims.

1. A method for distributing a multimedia message to a user having an electronic communication device comprising a packet based communication application stored thereon, the method comprising:
initiating a communication between the user and a recipient using the packet based communication application;
determining the availability of a multimedia message stored locally on the electronic communication device;
providing the locally stored multimedia message to the user;
connecting the user to the recipient for allowing a communication between the user and the recipient when the multimedia message has been provided to the user;
requesting an updated multimedia message based on a profile of the user, and
storing the updated multimedia message locally on the electronic communication device.

2. The method according to claim 1, further comprising:
providing information relating to at least one information parameters of the profile of the user and information relating to the provided multimedia message to a management server.

3. The method according to claim 1, wherein profile of the user comprises information parameters selected from the group comprising caller interests, hobbies, line of work, family status, geographical area, age and gender.

4. The method according to claim 1, wherein at least one information parameters of the profile is requested from an online community identifying the user.

5. The method according to claim 1, the electronic communication device further comprising an advertising delivery plug-in stored thereon, and the method further comprises intercepting the initiation of communication between the user and the recipient, wherein the advertising delivery plug-in performs determining the availability of and provision of the multimedia message and the request and storage of the updated multimedia message.

6. The method according to claim 5, wherein the advertising delivery plug-in further comprises requesting at least one information parameters of the profile from the packet based communication application.

7. The method according to claim 1, wherein a plurality of multimedia messages are stored locally on the electronic communication device, and one of the plurality of multimedia messages is selected to be provided to the user based on a plurality of predetermined criteria, the predetermined criteria selected from a group comprising priority of a specific multimedia message, the number of times a specific multimedia message has been provided to the user.

8. A computer readable medium on which a computer program for causing a control unit to apply the method of claim 1.

9. An electronic communication device, comprising a control unit configured to:
execute a packet based communication application on the control unit;
initiate a communication between the user and a recipient using the packet based communication application;
determine the availability of a multimedia message stored locally on the electronic communication device;
provide the locally stored multimedia message to the user;
connect the user to the recipient for allowing a communication between the user and the recipient when the multimedia message has been provided to the user;
request an updated multimedia message based on a profile of the user, and
store the updated multimedia message locally on the electronic communication device.

10. A server for managing delivery of a multimedia message to a user of an electronic communication device comprising a packet based communication application stored thereon, wherein the management server is configured to:
receive information relating to at least one information parameters of the profile of the user;
receive information relating to a multimedia message provided to the user of the electronic device;
match an updated multimedia message to the profile of the user, and
provide the updated multimedia message for the user.

11. The server according to claim 9, wherein the management server is further configured to:
connect to an online community identifying the user;
request at least one information parameters relating to the profile of the user, and
update the profile of the user based on the requested information parameter.

12. The server according to claim 10, wherein the management server is further configured to:
provide a user interface (UI) for operating the management server;
receive, by means of the UI, information relating to an advertisement campaign comprising at least one multimedia message;
provide, through the UI, information relating to at least one parameter of the profile of the user, and
provide, through the UI, information relating to the multimedia message provided to the user of the electronic device.

13. The server according to claim 12, wherein the management server is further configured to:
perform statistical analysis based on information relating to at least one information parameters of the profile of the user and information relating to a multimedia message provided to the user of the electronic device, and
provide, through the UI, campaign data based on the statistical analysis.
